(19) United States
(12) Patent Application Publication
(10) Pub. No.: US 2023/0006300 A1
(43) Pub. Date: Jan. 5, 2023

(54) Battery housing for a battery system

(71) Applicant: Webasto SE, Stockdorf (DE)

(72) Inventors: Michael Schönberger, Stockdorf (DE); Jochen Haussmann, Stockdorf (DE)

(21) Appl. No.: 17/781,673

(22) PCT Filed: Dec. 3, 2019
(86) PCT No.: PCT/EP2019/083466

§ 371 Date: Jun. 1, 2022

(51) Int. Cl. H01M 50/249; H01M 10/625; H01M 50/244; H01M 50/258; H01M 50/264

(52) U.S. Cl. CPC H01M 50/249; H01M 10/625; H01M 50/244; H01M 50/258; H01M 50/264; H01M 2220/20

(57) ABSTRACT

The present invention pertains to a battery housing for receiving battery cells, preferably for use in an electric or hybrid vehicle, the battery housing comprising a bottom plate forming a base of the housing, wherein the bottom plate is connectable to another bottom plate of the same kind by means of a connection system to form a modular bottom of the housing.

### CROSS-REFERENCE TO RELATED APPLICATION

This application is a 35 U.S.C. § 371 National Stage Entry of International Application No. PCT/EP2019/083466 filed Dec. 3, 2019, which is incorporated herein by reference in its entirety for all purposes.

### TECHNICAL FIELD

The invention relates to a battery housing which can be used to assemble a modular battery system as a traction battery for a hybrid or electrical vehicle.

### TECHNOLOGICAL BACKGROUND

Battery systems composed of multiple battery modules, wherein each battery module comprises a plurality of battery cells, are well known to be used as traction batteries in electric or hybrid vehicles. Battery modules forming the battery system have to be at least electrically connected. However, in order to enable a compact battery system which can be placed inside an electric vehicle for example, mechanical integrity is of great importance as well. Typically, a plurality of battery modules is placed inside a housing or on a carrier plate, in order to form a mechanically stable battery system.

To provide a more flexible battery system, a modular construction of the battery system is preferred. A modular battery system enables mechanical and electrical connection of an arbitrary number of battery modules in a battery housing.

DE 102013010001 A1 discloses a spring and groove connection between battery modules, which are placed inside the battery pack housing. DE 102013200383 A1, battery modules are connected to each other and to the carrier plate by one or more rods comprising bearing blocks on each side and means for pretension. DE 102008010822 A1 discloses a separate connection component for connecting battery modules to each other, for example a sliding connection.

DE 102016224442 A1 discloses a spring-groove connection component for connecting battery modules to each other. The spring and the groove parts are separate components, which are attached to the battery module housing by a clip connection. Additionally, battery modules are fixed to the battery pack housing by a screw, which is placed at the spring-groove connection site.

### SUMMARY OF THE INVENTION

It is an object of the present invention to provide an improved housing for receiving battery cells in a modular battery system, preferably for a hybrid or electric vehicle.

The object is solved by a battery housing defined as in claim 1. Preferred embodiments are defined in the dependent claims, the general description of the invention as well as the description of specific embodiments and the drawings.

Accordingly, a battery housing for receiving battery cells, preferably for use in an electric or hybrid vehicle, is suggested, wherein the battery housing comprises a bottom plate forming a base of the housing, wherein the bottom plate is connectable to another bottom plate of the same kind by means of a connection system to form a modular base of the housing.

By the provision of the connection system at the level of the bottom plate it is possible to assemble a modular battery system by connecting at least two adjacent bottom plates to one another and achieve a structurally sound arrangement. Depending on the actual needs of different specific vehicles, it is possible to adapt the dimensions of the resulting battery system while using the same bottom plates and in particular by using the same battery housings for a greater number of different vehicles and battery systems.

To achieve a fully modular battery system, battery housings may be mechanically connected to each other without use of a carrier plate. This can be achieved by using a plurality of like battery housings which each forms a battery module and the battery modules are directly mechanically connected to their respective neighbouring module to form a self-supporting battery system. This way, not only the number of modules in a battery system is variable, but also the shape of the battery system can be adapted to the available space. The connection between the respective battery modules should preferably enable an easy to assemble and mechanically stable battery system.

Preferably, the connection system is a clip connector system. The clip connector system enables fast and easy assembly, since no additional fastening means are needed.

Preferably, the bottom plate comprises at least a first edge and a second edge parallel to the first edge, wherein the first edge and the second edge form complementary portions of the clip connector system. For example, the first edge of the bottom plate may be formed as a male part of the clip connector system and the second edge may be formed as a female part of the clip connector system. The appropriate geometry for a clip connection between two battery housings is already incorporated into the corresponding bottom plates, therefore no extra assembly parts are needed for the connection of two or more such housings, which considerably simplifies assembly of the battery system.

Preferably, a gasket is arranged on the male and/or female part of the clip connector system to ensure a tight connection between two bottom plates, after the male and the female part of the clip connector system are tilted and pressed into the end position. The gasket may be placed into a recess of the male part of the clip connector system. The gasket may be made of one elongated piece of rubber or any other appropriate elastomeric material, running along the whole length of the edge of the respective bottom plate. The gasket may be made of several discrete pieces of rubber or any other appropriate elastomeric material being placed at discrete positions along the edge of the respective bottom plate.

Preferably, the gasket is an elastomer of the ethylene-propylene family such as EPDM, or of the butadiene styrene family such as latex or of the silicones family.

By placing the gasket at the connection site between the first and the second edge, the clip connection becomes tight and fixes the connected bottom plates in a plane. Additionally, the gasket may seal the connection between two bottom plates, such that it becomes impermeable to fluids.

Preferably, the bottom plate of the battery housing is self-supporting, meaning that no additional carrier plate or housing is needed to achieve a mechanically stable battery system. By this measure it is possible to build a mechanically intact modular battery system on the basis of the battery housings only.

Preferably, the battery housing comprises two side plates arranged on the bottom plate, wherein the inner sides of the two side plates and the bottom plate define an internal volume for receiving the battery cells. Each plate comprises a flange at its outer side and wherein each flange comprises fixation means for fastening the battery housing to an adjacent battery.

By using the flanges of the side plates of the battery housing, the battery housing can furthermore be attached directly to the chassis or to any other receiving frame.

Preferably, the bottom plate and/or the side plates are provided by an extruded material, preferably by an extruded profile and/or wherein the bottom plate and the side plates are integrally formed. Using extruded material and in particular extruded profiles the battery housing can be provided in a cost effective manner and infinite in dimensions along the extrusion direction.

Preferably, the bottom plate comprises fluid channels for receiving a temperature control fluid for to controlling the temperature of the battery cells received within the battery housing. This way the cooling/heating system is incorporated into the battery housing and no external system for temperature control is needed, which reduces weight, assembly time and production cost.

To maximize heat transfer between the fluid channels and the battery cells, in a preferred embodiment, the battery cells are positioned directly in the battery housing, preferably directly on the bottom plate and between the side plates of the battery housing for forming a battery module.

Preferably, the bottom plate comprises a venting channel for receiving gases released from battery cells in case of thermal runaway. The venting channel is connected to a common venting path, wherein the venting path connects venting outlets of all battery cells accommodated in the housing and conveys released gases to the venting channel and through it to the outside of the battery system.

The above mentioned object is also solved by a battery system with the features of claim 15.

Accordingly, the battery system comprises at least two battery housings for receiving battery cells wherein the battery housings are provided in the form as already discussed above and wherein the battery housings are interconnected at the respective adjacent bottom plates as well as at the respective adjacent flanges.

Mechanical connection of the bottom plates ensures stability of the connected battery housings in the plane defined by the bottom plate. By mechanically connecting the side plates of the two adjacent battery housings via their respective flanges, the stability of the battery system is further enhanced, since this way also the movement perpendicular to the bottom plates is suppressed. Furthermore, a connection in two planes which are distanced from each other is achieved.

### BRIEF DESCRIPTION OF THE DRAWINGS

The present disclosure will be more readily appreciated by reference to the following detailed description when being considered in connection with the accompanying drawings in which:

FIG. 1 illustrates a schematic perspective view of two connectable bottom plates in the process of being coupled;

FIG. 2 illustrates a schematic close-up view of a clip connector system;

FIG. 3 illustrates two connected battery housings, comprising bottom plates and side plates; and

FIG. 4 illustrates a schematic perspective view of a battery system with inserted battery cells.

### DETAILED DESCRIPTION OF PREFERRED EMBODIMENTS

In the following, the invention will be explained in more detail with reference to the accompanying figures. In the Figures, like elements are denoted by identical reference numerals and repeated description thereof may be omitted in order to avoid redundancies.

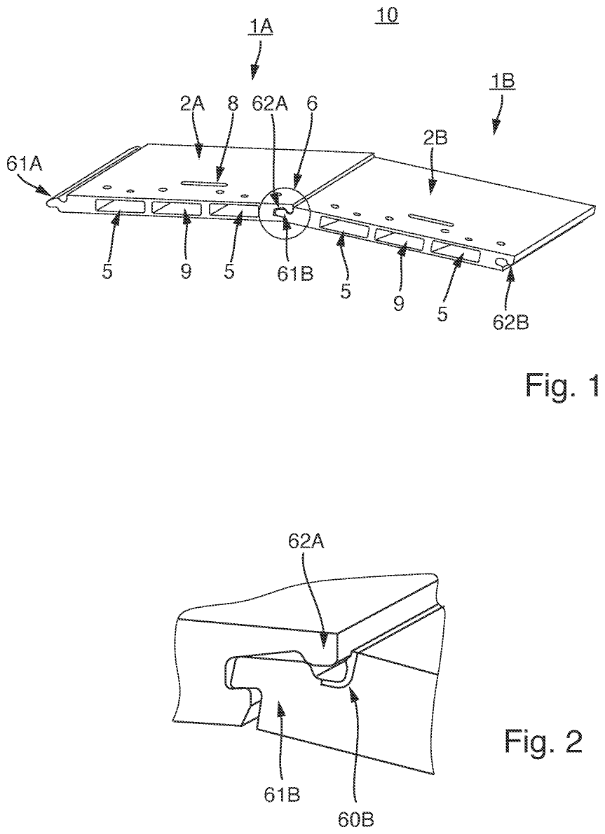

FIG. 1 illustrates a schematic view of two bottom plates 2A and 2B, pertaining to two battery housings 1A, 1B, which are shown in the process of being interconnected. Each bottom plate 2A, 2B comprises a first edge 61A, 61B, a second edge 62A, 62B parallel to the first edge.

The bottom plates 2A,2B may also include fluid channels 5 and/or a venting channel 9.

The terms “first” and “second” as well as the terms “left” and “right” are to be understood related to the Figures only and are intended to serve to more easily identify the different edges and/or sites of the battery housing 1A, 1B, specifically of the bottom plate 2A, 2B. The terms are, however, not to be interpreted in an absolute sense such that in a different perspective or orientation of the battery housing 1A, 1B , the “left” edge could also be on the right or at the back or at the front. Similarly, the numerators “first” and “second” are merely used to distinguish between two of the edges and can be used interchangeably and could also denote “third” or “fourth”.

Likewise the term “side” and “bottom” are to be understood with respect to the Figures which show a preferred example of orientation. However, the components could also be situated in a different location in a different perspective or orientation of the battery housing.

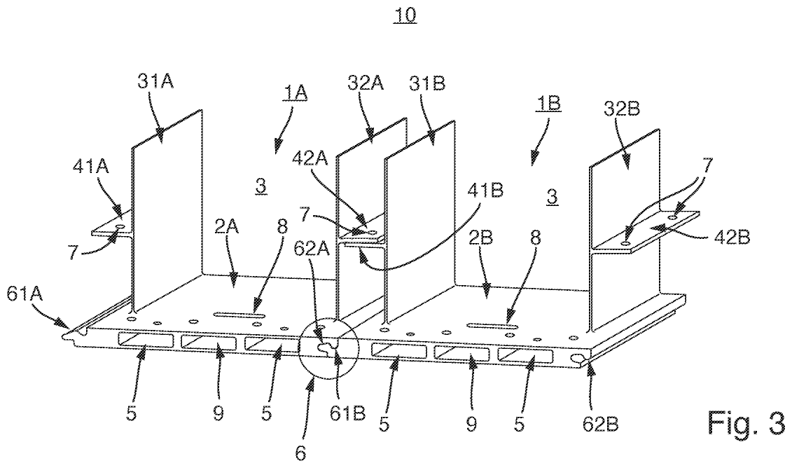

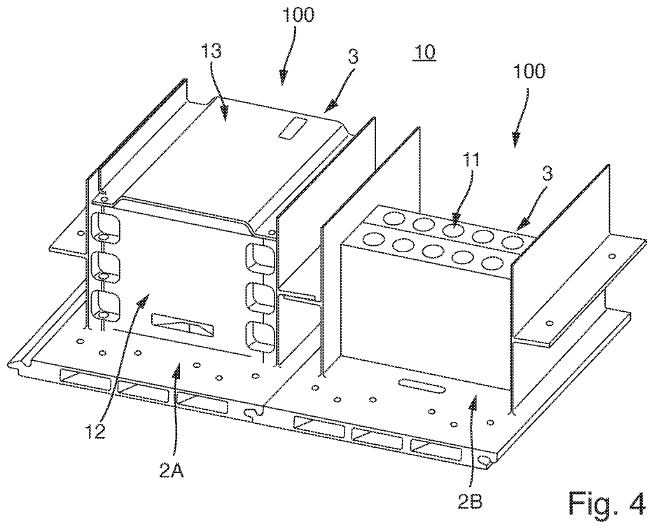

The battery housing 1A, 1B may also comprise side plates (left, right, front, back) and a cover plate, which together define an internal volume 3 of the battery housing 1A, 1B. A plurality of battery cells to may be received in the internal volume 3 of the battery housing 1A, 1B. The battery housing 1A, 1B together with battery cells (and any wiring/contact bars and/or control electronics may constitute a battery module 100. This will be shown with respect to FIGS. 3 and 4 below.

A plurality of battery modules 100 may be combined to a battery system 10 for a hybrid or electrical vehicle. This will be shown in more detail in FIG. 4. The battery system 10 preferably serves as a traction battery for providing an electric drive of the hybrid or electric vehicle with electric power.

Turning back to FIG. 1, the bottom plate 2A, 2B of the battery housing 1A, 1B is preferably self-supporting, such that no additional carrier plate or housing is needed to hold the weight of the battery module 1A, 1B including the components received in the internal volume 3 during use. Such self-supporting bottom plate 2A, 2B may be produced by an extrusion process.

The bottom plate 2A, 2B can hence be made of an extruded aluminum profile, an aluminum casting part, reinforced plastic extrusion profile or casting part or of an aluminum or steel deep drawn part.

Further, the bottom plates 2A, 2B preferably comprise at least one fluid channel 5 for receiving a temperature control fluid for controlling the temperature of the internal volume 3 and, thus, of the battery cells received therein.

Providing temperature control of a battery module or a battery in a battery housing by means of a temperature control fluid is, in principle, known. If cooling of the battery components is required, the temperature control fluid is typically processed to have a lower temperature than the temperature in the internal volume 3. If a heating of the battery components is required, the temperature control fluid is typically processed to have a higher temperature than the temperature in the internal volume 3. The temperature control fluid is made to flow through the fluid channels 5 in order to enable temperature control of the inner volume 3 by means of heat exchange.

There are two fluid channels 5 implemented in each of the bottom plates 2A, 2B, which are part of the extruded profile forming the bottom plates 2A, 2B. The fluid channels 5 run in parallel to each other in the exemplary implementation of this invention. However, the number and realization of fluid channels may vary in different implementations of this invention. The fluid channels 5 are a feature of the extruded profile.

The bottom plate 2A, 2B may also comprise a venting channel 9 for receiving gases released from the battery cells in case of a thermal runaway. A venting opening 8 connects a common venting arrangement to the venting channel 9. The common venting arrangement is arranged such that the venting outlets of a number or all battery cells received in the inner volume 3 of the battery housing 1A, 1B are combined and connected such that gases released by one or more than one battery cells are conveyed to the venting channel 9 and through it to the outside of the battery system. In other words, the common venting arrangement acts as a manifold for the venting outlets of the individual battery cells.

Two opposing edges 61A, 62A of the bottom plate 2A that may run parallel to fluid channels 5, show a complementary geometry in order to enable a direct connection between at least two such adjacent bottom plates 2A, 2B, which will further be explained with reference to FIG. 2. The edges 61A, 61B, 62A, 62B of the bottom plate 2A, 2B run along the extrusion direction if the respective bottom plate 2A, 2B is made in an extrusion process.

In the Figures and preferred embodiments, the direct connection between adjacent bottom plates 2A, 2B is formed as a clip connection 6 such that each two bottom plates 2A, 2B can be securely connected to each other without needing any additional fastening means.

By connecting the bottom plates 2A and 2B at their edges, a self-supporting structure for a carrier plate of a battery housing can be provided. In other words, the connected bottom plates provide the carrier plate of the battery housing such that it is not necessary to provide a separate carrier plate but the connected bottom plates can be used for this purpose.

FIG. 2 illustrates a schematic view of the clip connector system 6, connecting two bottom plates 2A and 2B, and comprising the first edge 61B of the bottom plate 2B, which is formed as a male part of the clip connector system and the second edge 62A of the bottom plate 2A, which is formed as a female part of the clip connector system and is parallel to the first edge 61B.

A gasket 60B is placed into a recess of the male part 61B of the clip connector system.

The gasket may also be fixed to the male part of the connector system, for example the gasket may be glued to the male part of the clip connector system. The gasket may also just be placed into the concave geometry of the male part of the clip connector system before connection of the two bottom plates 2A, 2B takes place during assembly of the battery system 10. The gasket may also be applied on the edge of the bottom plate before battery assembly.

The gasket may also stretch outside of the concave geometry of the male part of the clip connector system, the gasket may also completely cover the male part of the clip connector system. The gasket may similarly be attached to the female part of the clip connector system. The gasket may be comprised of one piece extending along the whole length of the respective edge of the corresponding bottom plate. The gasket may also be comprised of several pieces, being placed in discrete intervals along the edge of the corresponding bottom plate.

The gasket 60B may be an elastomer of the ethylene-propylene family such as EPDM (ethylene propylene diene monomer), or of the butadiene styrene family such as latex or of the silicones family. The gasket may also be made of thermoplastic elastomers.

The gasket 60B is pressed between the first and the second edge 62A, 61B of the corresponding bottom plates 2A, 2B, when the male 61B and the female 62A part of the clip connector system are pushed together into the end position in order to connect the two bottom plates 2A, 2B to each other. This enables a tight connection between the two bottom plates 2A, 2B, which is additionally stabilized by connecting side plates which will explained with respect to FIG. 3. The clip connector system 6 enables a tight but at the same time easily detachable connection between the two bottom plates 2A, 2B, which enables easy mounting and dismounting of a battery system and therewith easy maintenance in case of a failure of a specific battery module 100.

FIG. 3 illustrates a schematic view of a battery system 10 comprising two battery housings 1A, 1B being connected, wherein each housing comprises a bottom plate 2A, 2B and two side plates 31A, 32A, 31B, 32B, arranged on the bottom plate 2A, 2B.

The battery housing 1A, 1B comprises a bottom plate 2A, 2B and two side plates 31A, 32A, 31B, 32B arranged on the bottom plate 2A, 2B. The bottom plate 2A or 2B together with side plates 31A, 32A or 31B, 32B defines the internal volume 3 of the battery housing 1A, 1B.

Bottom plate 2A, 2B and the side plates 31A, 32A, 31B, 32B may be formed integrally—for example by extrusion.

In a different embodiment, side plates 31A, 32A, 31B, 32B may be fixed to the bottom plate 2A, 2B by a screw connection or by a form-locking connection or by any other appropriate connection that offers sufficient stability. Side plates 31A, 32A, 31B, 32B may also be glued or welded to the bottom plate 2A, 2B.

Preferably, the bottom plate 2A, 2B and the side plates 31A, 32A, 31B, 32B are made of same material, preferably aluminum, or different materials with similar temperature coefficients, to avoid damage due to different temperature deformations.

Each side plate 31A, 32A, 31B, 32B comprises a corresponding flange 41A, 42A, 41B, 42B on its outer side. The term “outer side” is intended to refer to the side of the side plates 31A, 32A, 31B, 32B which does not define the internal volume 3. In other words, the flanges 41A, 42A, 41B, 42B extend away from the internal volume 3.

Attachment of the respective battery housings 1A and 1B to each other takes place at two separate connection sites which are placed in two different planes relative to the bottom plate 2A. The first connection site is realized through connection of the bottom plates 2A and 2B to each other and is situated in the plane defined by the bottom plates 2A, 2B. The second connection site is realized by connecting the flanges 42A, 41B of the corresponding side plates 32A, 31B to each other and is realized in a plane parallel but distanced to the plane defined by the bottom plates 2A, 2B.

Bottom plates 2A and 2B are connected along the edges 62A and 61B by a clip connection as explained with reference to FIG. 2. The edges 62A and 61B have a complementary geometry, such that after tilting and pressing both edges 62A and 62B towards each other, a tight connection between the two bottom plates 2A and 2B results in the plane defined by the bottom plates 2A, 2B.

After tilting and connecting adjacent bottom plates 2A and 2B to each other, the adjacent flanges 42A, 41B automatically come into close contact and are aligned with each other.

For this to happen, the flanges 41A, 41B on the left side plates 31A, 31B and the flanges 42A, 42B on the right side plates 32A, 32B are positioned at slightly different heights with respect to the bottom plates 2A, 2B, approximately midway along the side plates. The difference in height preferably roughly corresponds to the thickness of material of the flanges 41A, 41B, 42A, 42B such that any respective two adjacent flanges 42A, 41B do not collide but smoothly overlap.

In this process the holes 7 of the respective adjacent flanges 42A, 41B also slide into registration with each other such that the holes 7 on flanges 42A and 41B are finally positioned so, that after connecting the bottom plates 2A and 2B, the holes overlay. Screws may be placed into the holes 7 to fasten the flanges 42A and 41B to each other.

By such double connection of the battery housings 1A, 1B, in particular in two planes distanced from each other, an especially stable and self-supporting battery system 10 may be provided. By using the flanges 41A and 42B at the outer side of the battery system 10, the battery system 10 may additionally be fastened to a chassis or to any other receiving frame without using the carrier plate or additional housing.

In FIG. 3 the situation is shown in which two battery housings 1A, 1B are finally connected. However, more than two battery housings 1A, 1B can be combined to form a modular battery system 10 of dimensions needed for the respective purpose.

FIG. 4 illustrates a battery system 10 composed of two battery housings and with battery cells 11 inserted in the inner volume 3 between the bottom plate 2A or 2B and the side plates 31A and 32A or 31B and 32B. The battery cells 11 may be in direct contact with the bottom plate 2A, 2B and thus thermally coupled to the fluid channels 5 which are incorporated in the bottom plate 2A, 2B. The battery housing 1A and battery cells 11, together with a front plate 12, a back plate (not shown in the Figure but similar to the front plate 12) and the module cover 13 hence form a battery module 100. A suitable number of such battery modules 100 may be connected together, to form a battery system 10 of desired size.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

1A, 1B battery housing

2A, 2B bottom plate

3 internal volume

31A, 32A, 31B, 32B side plate

41A, 42A, 41B, 42B flange

5 fluid channel

6 clip connection

61A, 61B male part of a clip connector system

62A, 62B female part of a clip connector system

60B gasket

7 holes for screws

8 opening for venting system

9 venting channel

10 battery system

11 battery cell

12 front plate

13 module cover

100 battery module

1. A battery housing for receiving battery cells, wherein the battery housing comprises bottom plate forming a base of the battery housing, wherein the bottom plate is connectable to another bottom plate of the same kind by a connection system to form a modular base of the battery housing.

2. The battery housing according to claim 1, wherein the connection system is a clip connector system.

3. The battery housing according to claim 2, wherein the bottom plate comprises at least a first edge and a second edge parallel to the first edge, wherein the first edge and the second edge form complementary portions of the clip connector system.

4. The battery housing according to claim 3, wherein the geometry of the first edge of the bottom plate is formed as a male part of the clip connector system and the geometry of the second edge is formed as a female part of the clip connector system.

5. The battery housing according to claim 4, wherein a gasket is arranged on at least one of: the male and the female part of the clip connector system to ensure a tight connection between the two bottom plates, after the male and the female part of the clip connector system are tilted and pressed into an end position.

6. The battery housing according to claim 5, wherein the gasket is placed into a recess of the male part of the clip connector system to ensure a tight connection between the two bottom plates after the male and the female part of the clip connector system are tilted and pressed into the end position.

7. The battery housing according to claim 5, wherein the gasket is made of an elongated piece of at least one of: rubber and an appropriate elastomeric material, running along a whole length of the edge of the respective bottom plate.

8. The battery housing according to any of claim 7, wherein the gasket is an elastomer of at least one of: the ethylene-propylene family, the butadiene styrene family, and the silicones family.

9. The battery housing according to claim 8, wherein the bottom plate is self-supporting.

10. The battery housing according to claim 9, wherein the battery housing further comprises two side plates arranged on the bottom plate, wherein inner sides of the two side plates and the bottom plate define an internal volume for receiving the battery cells, wherein each side plate comprises a flange at its outer side, and wherein each flange comprises fixation for fastening the battery housing to an adjacent battery housing.

11. The battery housing according to claim 10, wherein at least one of: the bottom plate and the side plates are provided by an extruded material.

12. The battery housing according to claim 11, wherein the bottom plate comprises fluid channels for receiving a temperature control fluid for controlling the temperature of the battery cells received within the battery housing.

13. The battery housing according to claim 12, wherein the battery cells are positioned directly in the battery housing, directly on the bottom plate and between the side plates of the battery housing for forming a battery module.

14. The battery housing according to claim 13, wherein the bottom plate comprises a venting channel for receiving gases released from the battery cells in case of thermal runaway.

15. A battery system comprising at least two battery housings for receiving battery cells, wherein the battery housings are interconnected at respective adjacent bottom plates as well as at respective adjacent flanges.

16. The battery system of claim 15, wherein each battery housing of the at least two battery housings comprises a bottom plate forming a base of the battery housing, wherein the bottom plate is connectable to another bottom plate of the same kind by a connection system to form a modular base of the battery housing.

17. The battery housing according to claim 1, wherein the received battery cells are configured for use in at least one of: an electric vehicle and a hybrid vehicle.

18. The battery housing according to claim 3, wherein the geometry of the first edge of the bottom plate is formed as a female part of the clip connector system and the geometry of the second edge is formed as a male part of the clip connector system.

19. The battery housing according to claim 5, wherein the gasket is made of several discrete pieces of at least one of: rubber and an appropriate elastomeric material being placed at discrete positions along the edge of the respective bottom plate.

20. The battery housing according to claim 10, wherein the bottom plate and the side plates are integrally formed.
